(19) United States
(12) Patent Application Publication
(10) Pub. No.: US 2007/0035152 A1
(43) Pub. Date: Feb. 15, 2007

(54) Covering system for a truck

(75) Inventors: Robert A. Talbot, Holland, MA (US); Howard A. Greis, Holden, MA (US)

Correspondence Address: YOUNG & BASILE, P.C., 3001 WEST BIG BEAVER ROAD, SUITE 624, TROY, MI, 48084, US

(73) Assignee: Pioneer Consolidated Corp., North Oxford, MA (US)

(21) Appl. No.: 11/583,531

(22) Filed: Oct. 19, 2006

Related U.S. Application Data
(63) Continuation-in-part of application No. 11/083,720, filed on Mar. 18, 2005.

(51) Int. Cl. B60P 7/02

(52) U.S. Cl. 296/100.1

(57) ABSTRACT

An apparatus for opening and closing a cover of a truck is disclosed. The apparatus includes a rotatable shaft that can be connected to multiple support anchors in order to provide a torsion force to each of the supports to pivotably rotate the supports and the cover between an opened position and a closed position. The support anchors are attachable to the cover and are pivotably attached at an end of each support to the rotatable shaft. A plurality of offset hinges pivotably attaches the shaft to the container and rotatably receives the shaft. An actuator is used to provide rotary motion to the shaft. The actuator includes hydraulic cylinders and a chain and sprocket for converting linear motion of the cylinder to rotary motion of the shaft.

### CROSS-REFERENCE TO RELATED APPLICATIONS

This application is a continuation in part and claims the benefit of the priority of the Mar. 18, 2005 file date of U.S. patent application Ser. No. 11/083,720, which is incorporated herein in its entirety by reference.

### FIELD OF THE INVENTION

The present invention relates to a covering system for covering a cargo area of a truck.

### BACKGROUND OF THE INVENTION

Open top containers associated with a truck or truck trailer are used for hauling loads of material or refuse. Typically, these containers are equipped with a covering system for the open top for covering at least a portion of the open top. The cover can prevent the load of the container from blowing or falling out of the container and/or protect the load from exposure to weather conditions and/or insulate for heat retention in the case of an asphalt load.

Some prior cover systems have an accordion type design in which the cover moves from the front to rear of the container on a rail system. As a result of this motion, in an open position, the cover is folded into an accordion type design, taking up vertical space of the container. The cover system also has opening and closing problems when the container is overfilled. In addition, the time used in opening and closing the cover is much longer than other systems, such as side opening cover systems.

In a typical side opening covering system, a cover or tarpaulin is attached to a frame having numerous supports to form a cover assembly. The supports extend across the width of the container and are evenly spaced along the length of the container in order to provide support for the cover. The supports, which can be bow supports, are usually pivotably attached at one end to a side of the container to allow the cover assembly to move between a covered position and an uncovered position with respect to the open top of the container. Typically, the covering assembly would be moved to a covered position for transit and to an uncovered position for loading and unloading of the container.

Prior covering systems of this type typically open and close the cover assembly by moving a lead support 100 as illustrated in FIG. 20. The lead support 100 is attached to the container, and moving the lead support 100 in turn rotates the cover 102, which includes a structure connecting the remaining supports and a covering material.

Because the forces and torques for opening and closing the cover assembly are exerted through the lead support and not directly on each of the supports, this causes deflection and stress on the cover assembly that can result in reduced longevity. Safety is also increased by eliminating the 20° lag that is present in the prior cover systems. In the prior cover systems, as the support members are individually driven, a 20° lag is present as the cover is closing until the cover is directly above the center of the axis of rotation, at which point the cover picks up momentum and becomes ahead by 20°. This causes the cover to slam closed, increasing the risk of safety and adds additional wear on the system.

Thus, it would be desirable to eliminate or minimize deflection and stress on the cover assembly.

### SUMMARY OF THE INVENTION

The present invention provides an apparatus for opening and closing a cover of an open top container of a truck. The apparatus can include a plurality of supports attachable to the cover and means for moving each of the supports between an opened position and a closed position. The pivotally attaching means can include a plurality of hinges. The moving means can include a shaft, which is formed by a plurality of shorter shafts axially coupled together, and an actuator for providing rotary motion to the shaft. The plurality of hinges can be used to pivotably attach the supports to the container and can rotatably receive the shaft proximate to and parallel to the one side of the container.

The actuator can include at least one hydraulic cylinder, which, by example, can be a reversible hydraulic cylinder. A chain is attachable to at least one rod of the hydraulic cylinder and is operably engaged with a sprocket attachable to the shaft in order to translate linear motion of the cylinder to rotary movement of the shaft.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a front perspective view of an open top container of a truck according to a first embodiment of the present invention having a drive shaft with yoke-type connectors for covering the top of the container;

FIG. 2 is a side elevational view of the container and apparatus shown in FIG. 1;

FIG. 3 is a front view of the container illustrating the apparatus in an opened position with respect to the container;

FIG. 4 is a front view of the container illustrating the apparatus in an partially opened position with respect to the container;

FIG. 5 is a front view of the container illustrating the apparatus of FIG. 1 in an closed position with respect to the container;

FIG. 6 is a simplified partial side elevational view of the apparatus proximate to a front of the container depicted in FIGS. 1 and 2 showing a drive shaft having yoke-type connectors;

FIG. 7 is a simplified partial side elevational view of the apparatus proximate to a rear of the container depicted in FIGS. 1 and 2 showing the drive shaft having yoke-type connectors;

FIG. 8 is a simplified partial cross sectional view of the apparatus taken generally along line 8-8 of FIG. 6 showing a hinge of the apparatus in the closed position with respect to the container;

FIG. 9 is a simplified partial cross sectional view of the hinge taken generally along line 9-9 of FIG. 6;

FIG. 10 is a simplified partial cross sectional view of a shaft support member of the apparatus taken generally along line 10-10 of FIG. 6;

FIG. 11 is a side elevational view of a closed top container of a truck according to a second embodiment of the present invention having a drive shaft with sleeve-type connectors for covering the top of the container;

FIG. 12 is a simplified partial side elevational view of the apparatus proximate to a front of the container depicted in FIG. 11 showing the drive shaft having sleeve-type connectors;

FIG. 13 is a simplified partial side elevational view of the apparatus proximate to a rear of the container depicted in FIG. 11 showing the drive shaft having sleeve-type connectors;

FIG. 14 is a simplified partial cross sectional view of the apparatus taken generally along line 14-14 of FIG. 13 showing a hinge and anchor support of the second embodiment in the closed position with respect to the container;

FIG. 15 is a simplified partial cross sectional view of the hinge of the second embodiment taken generally along line 15-15 of FIG. 12;

FIG. 16 is a simplified partial cross sectional view of an anchor support member of the second embodiment taken generally along line 16-16 of FIG. 13;

FIG. 17 is a simplified partial cross sectional view of an anchor support member of the second embodiment taken generally along line 16-16 of FIG. 13, in which the cover is in the open position;

FIG. 18 is a front view of an actuator according to a first embodiment of the present invention having one hydraulic cylinder and two sprockets;

FIG. 19 is a front view of an actuator according to a second embodiment having two hydraulic cylinders and a single sprocket; and

FIG. 20 is a front perspective view of a truck showing an example of a prior art cover in a partially opened position with respect to an open top container of the truck.

### DETAILED DESCRIPTION OF EMBODIMENTS OF THE INVENTION

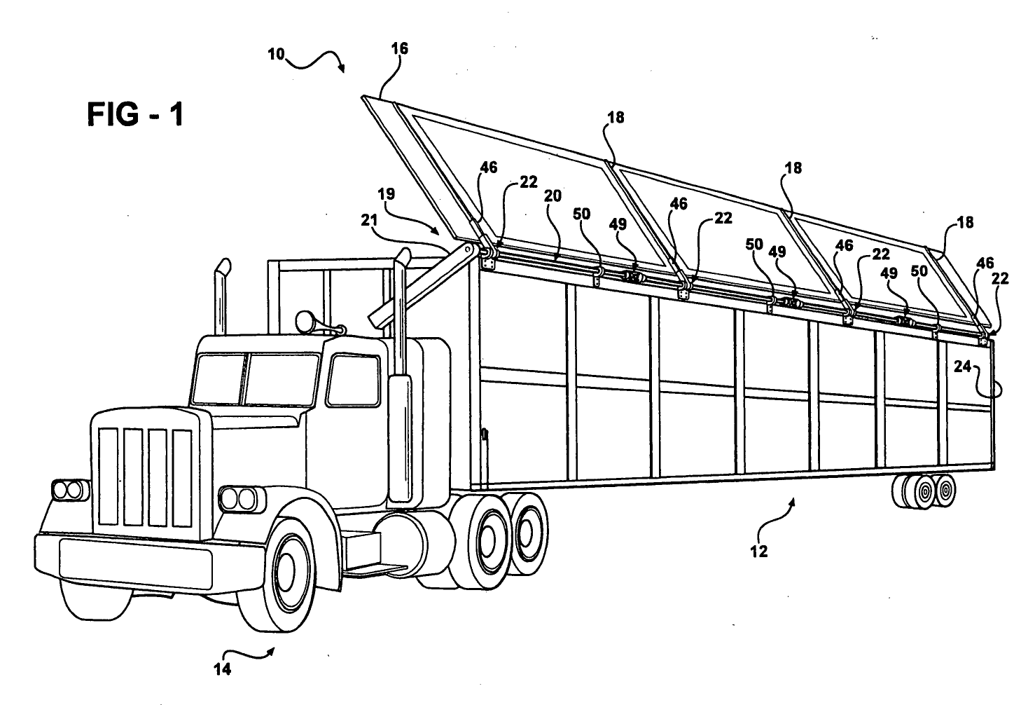

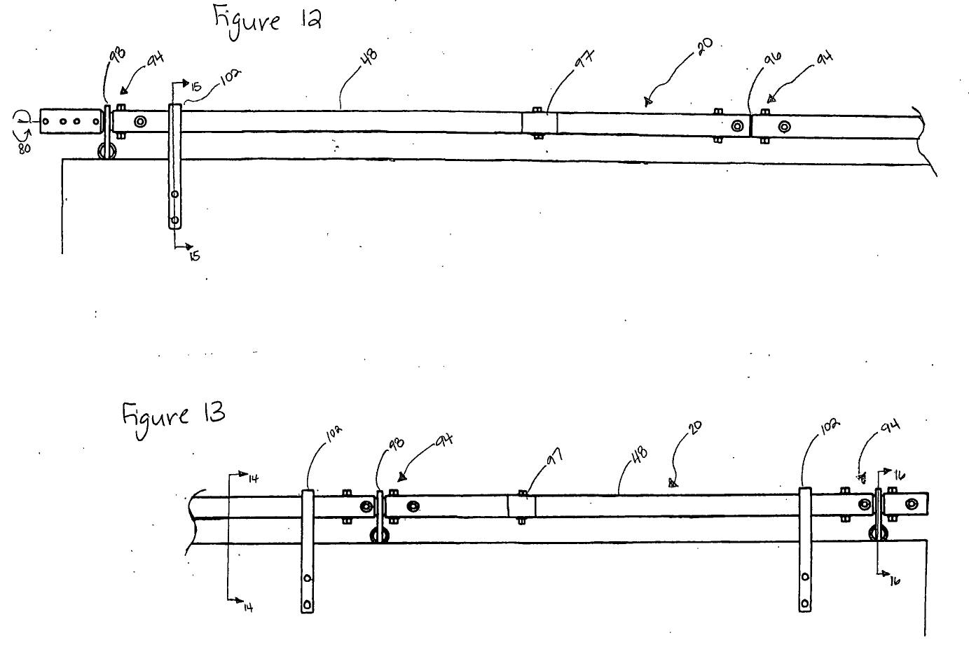

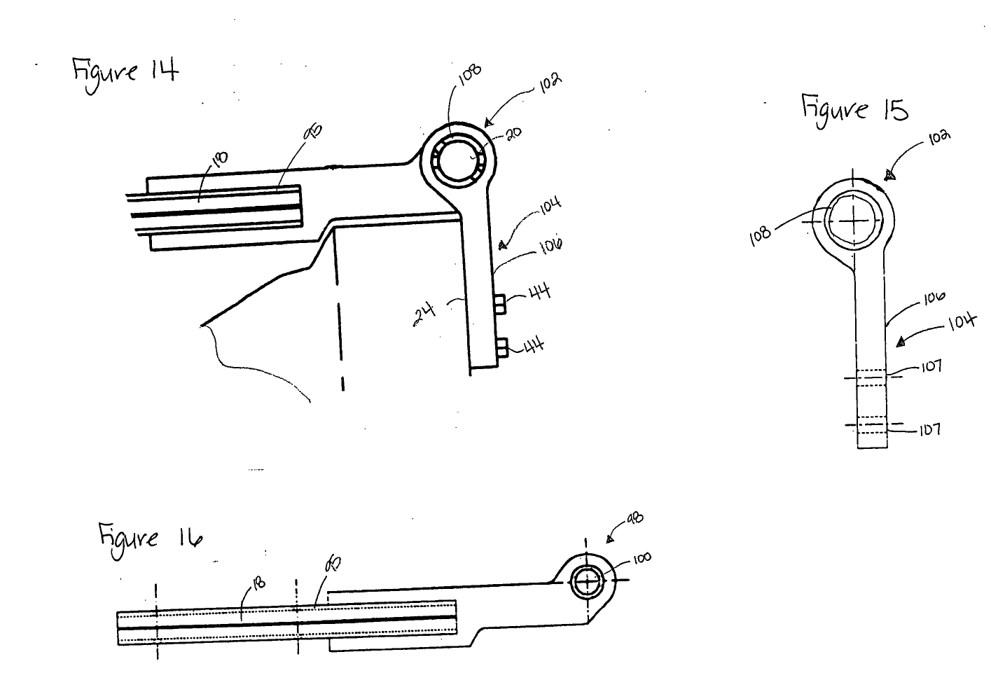

Referring to FIGS. 1-19, an apparatus 10 for covering a top 11 of a container 12 of a truck or truck trailer 14 is disclosed. A cover 16 is attached to a plurality of cover supports 18. By way of example and not limitation, the cover 16 can be a tarpaulin material and/or a mesh material. The supports 18 are moved between an opened position and a closed position with respect to the container 12 by moving means 19, which include a shaft 20 and an actuator 21. The shaft 20 provides an equal torque to each support 18 in order to rotatably move the supports 18 and the cover 16 between an opened position and a closed position with respect to the container 12. The shaft 20 can be, for example, hexagonal, rectangular, polygonal, round and/or tubular in cross-section as shown in FIGS. 8-10. The tubular shaft provides maximum torsional stiffness with minimum weight.

In an embodiment shown in FIGS. 1-2 and 6-7, the shaft 20 includes multiple shaft lengths 48, preferably eight-foot in length, attachable end to end by shaft connectors, which are shown but not limited to, yoke connectors 49. The multiple shaft sections 48 allows for easy modification of the shaft 20 length to accommodate trailer length variation, easy shipment for field installation, and simplified installation.

As illustrated in FIGS. 1-2 and 6-10, means for pivotally attaching the supports 18 to the container 12 include a plurality of support hinges 22, each for pivotally attaching one support 18 to a side 24 or top 11 of the container 12. The supports 18, the shaft 20, and the hinges 22 can be formed of a metal material such as steel. The metal material can be a coated material to prevent corrosion.

Referring to FIGS. 8 and 9, a detailed view of one hinge 22 is shown. The hinge 22 includes a fixed member 36 that can be attached to the side 24 or top 11 of the container 12 and a movable member 38 attached to respective supports 18.

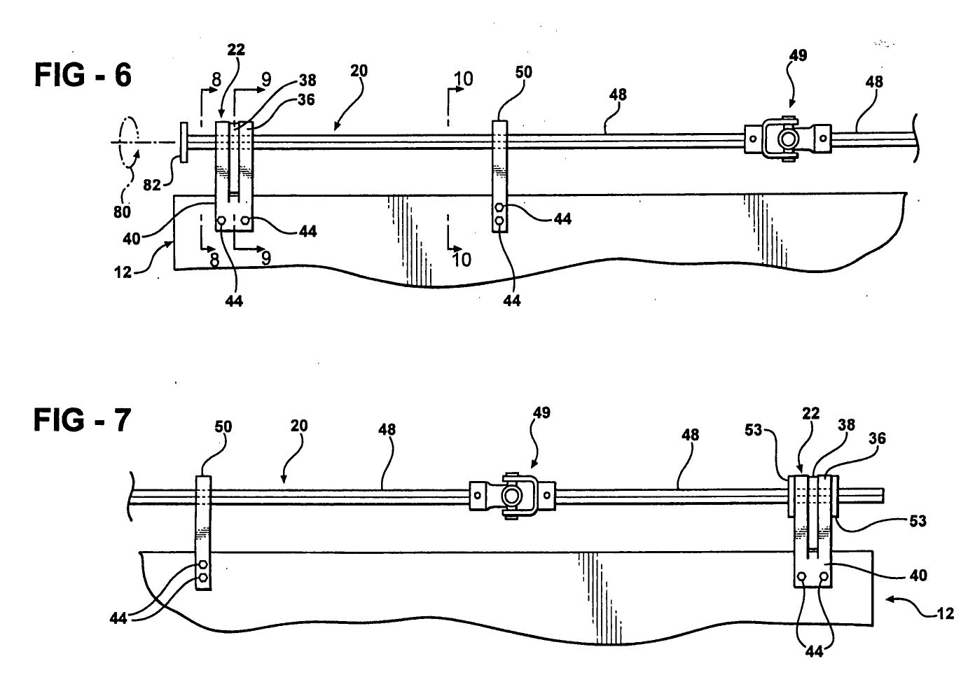

As best seen in FIGS. 6-7 and 9-10, the fixed member 36 shown includes a mounting bracket 40, which is integrally formed with the fixed member 36 and includes at least one aperture 42 for each receiving a fastener 44 for attaching the fixed member 36 to the side 24 of the container 12. The mounting bracket 40 is generally rectangular in shape, for example. The fastener 44 is a bolt and/or a screw. Each fixed member 36 include at least one shaft bearing or bushing 45 for rotatably receiving the shaft 20 to allow rotation of the shaft 20 with respect to the fixed member 36.

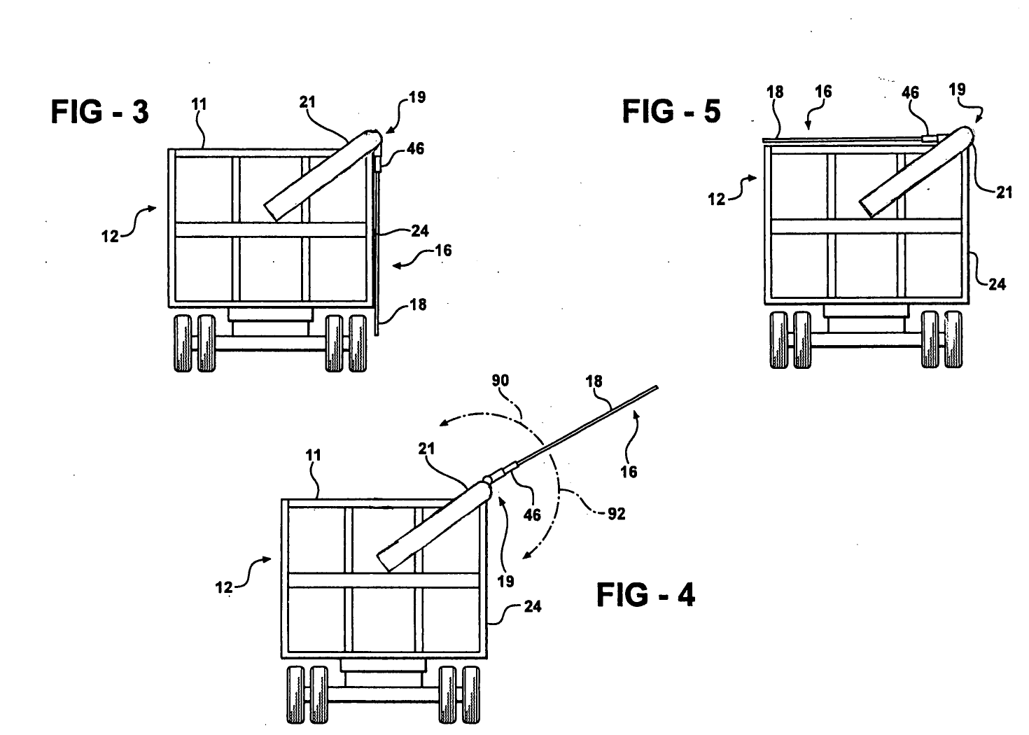

The movable member 38 includes a connector, which also includes a sleeve 46 for connecting each support 18 to each movable member 38 as shown in FIGS. 1, 3-5, and 8-9. The shaft 20 is fixedly attached to each movable member 38 and is rotatably received by each fixed member 36. According to one way of fixing the shaft 20 to the movable member 38, the movable member 38 has a shaft aperture 47 with a complementary shape to the shaft 20 in order to fix the shaft 20 with respect to the movable member 38. As the shaft 20 rotates, each movable member 38 rotates with respect to the container 12, and thus each support 18 rotates. Rotation of the shaft 20 thus causes the supports 18 to rotate with respect to the container 12 between a closed position as shown in FIG. 3, a partially opened position as shown in FIG. 4, and an opened position as shown in FIG. 5.

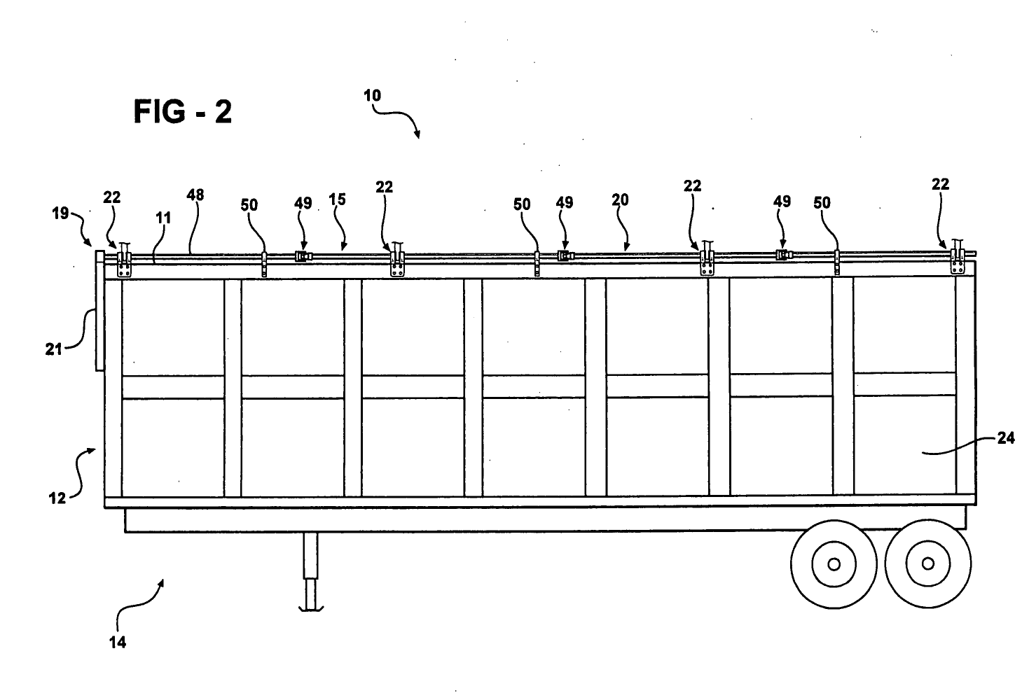

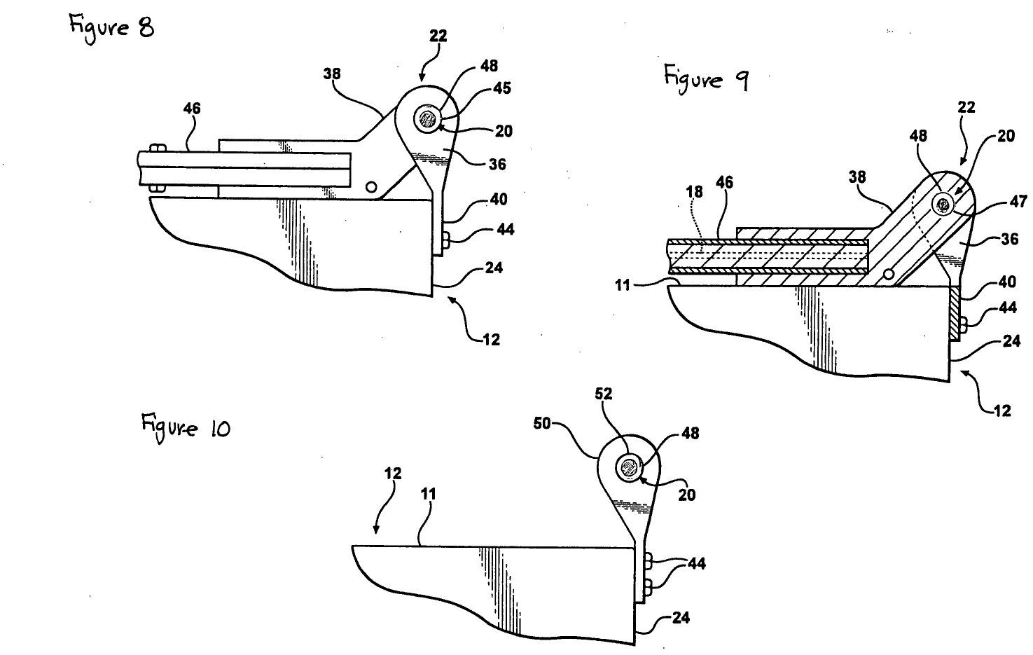

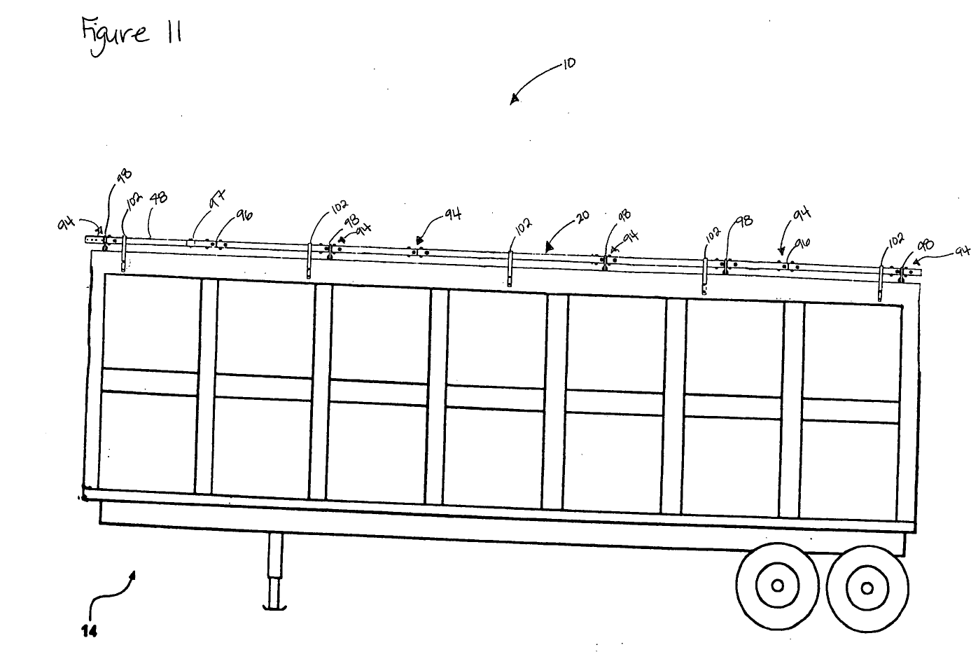

Optionally, multiple shaft support members 50 provide support to the shaft 20 and are spaced between support hinges 22 as shown in FIGS. 1 and 2. Each support member 50 includes at least one support bearing or bushing 52 (shown in FIG. 10) for rotatably receiving the shaft 20 to allow rotation of the shaft 20 with respect to the support member 50. Each support member 50 is attached to the container 12 using at least one fastener 44 or any such suitable means as are known in the industry. Preferably, at least one pair of retainers 53 are mounted on respective sides of each hinge 22 and, optionally, each support member 50 to prevent linear movement of the shaft 20 relative to the container 12. The retainers 53 are generally disk-like in shape and each retainer 53 in each pair is attached to the shaft 20 on an opposite side of one hinge 22 relative to another retainer 53 in the pair.

In an alternative embodiment shown in FIGS. 11-17, the shaft 20 includes a plurality of shaft lengths 48 that are axially coupled together by bolt type sleeve-type connections 94. At the sleeve-type connections 94, between the shaft lengths 48, are either shaft connectors 96 or movable support anchor members 98.

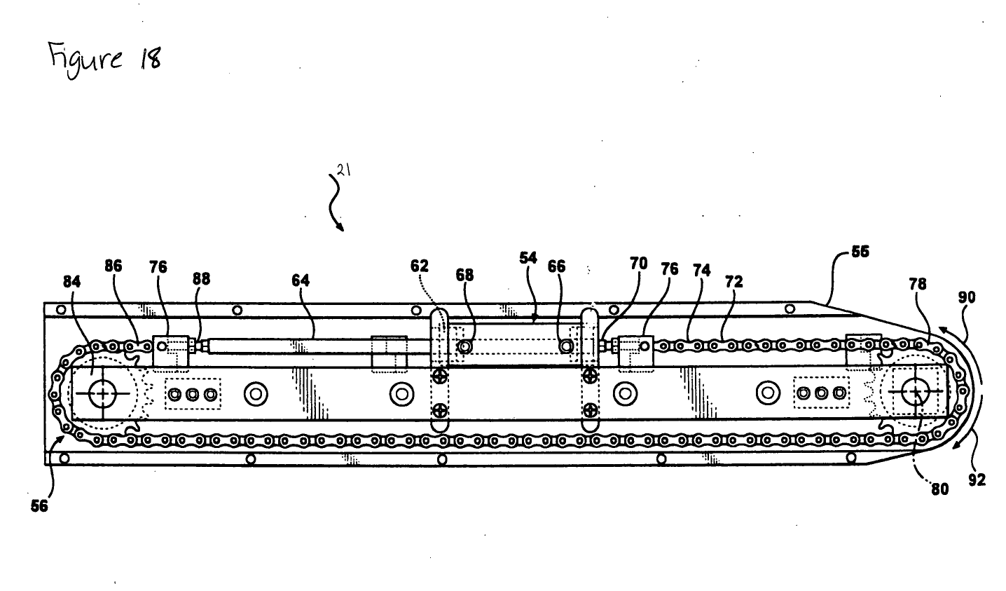

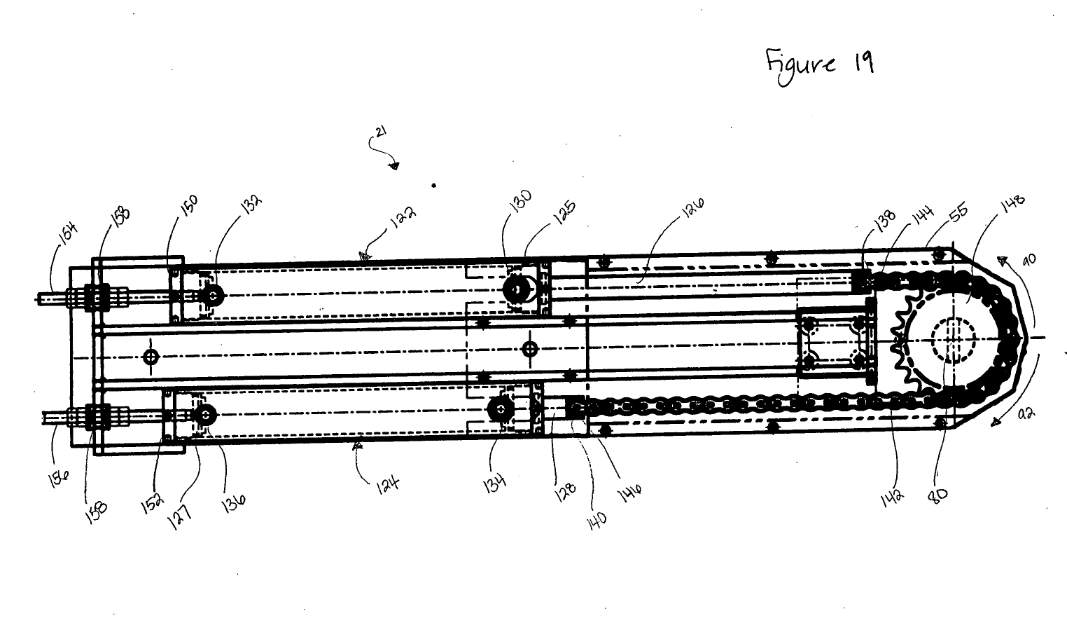

As shown in FIGS. 16 and 17, the movable support anchor member 98 includes a split sleeve 95 for connecting each support 18 to each support anchor member 98 as shown in FIGS. 3-5, 14, and 16-17. The support anchor member 98 has a shaft aperture 100 with a complementary shape to the shaft 20 in order to receive the shaft 20 with respect to the support anchor member 98. As the shaft 20 rotates, each support anchor member 98 rotates with respect to the container 12, and thus each support 18 rotates. Rotation of the shaft 20 thus causes the supports 18 to rotate with respect to the container 12 between a closed position as shown in FIG. 3, a partially opened position as shown in FIG. 4, and a fully opened position at a 270 rotation as shown in FIG. 5. The support anchor members 98 are not fixed to the container 12 and float on the top edge of the container, providing the shaft 20 with longitudinal resilience so that the shaft 20 can conform to deflection of the container sidewalls. However, the support anchor members 98 are fixed longitudinally in position along the shaft 20 between the shaft section 48 ends in the sleeve-type connections 94. The sides of the support anchors 98 can be welded to the shaft section 48 ends to fix the support anchors 98 to the shaft 20.

As shown in FIGS. 11-13 the shaft 20 receives four support anchors 98 to attach to the respective cover support members 18; one support anchor 98 at the forward end of the shaft, one support anchor 98 at the latter end of the shaft 20, and two support anchors 98 spaced between the support anchors 98 at the shaft 20 ends. Each support anchor 98 is placed between shaft sections 48 at the sleeve-type connections 94. The remaining sleeve-type connections 94 have axle connectors 96 between the shaft sections 48.

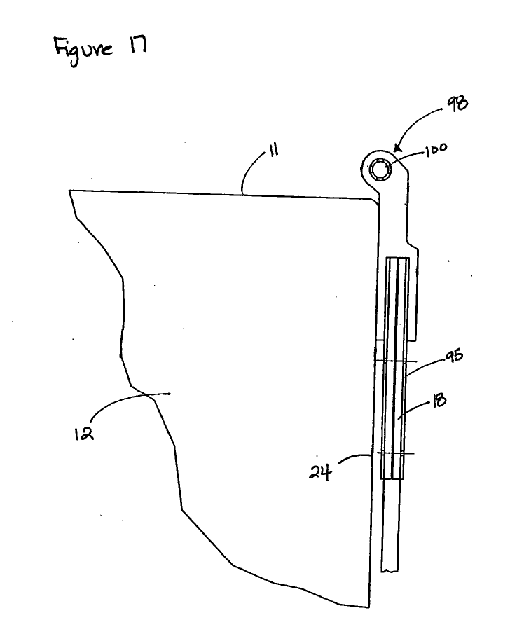

As shown in FIGS. 11-15, means for pivotally attaching the shaft 20 to the container 12 include a plurality of offset support hinges 102. Referring to FIGS. 14 and 15, a detailed view of the offset hinge 102 is shown. The offset hinge 102 includes a fixed portion 104 that is attached to the side 24 of the container 12. In an unassembled position, the fixed portion 104 of the hinges 102 are not fixed in position along the shaft 20 on the container 12. During assembly the offset hinges 102 are spaced along the shaft 20 and fixed at the desired locations on the container 12 to provide support to the shaft 20 as shown in FIG. 11.

As best seen in FIGS. 14 and 15, the fixed portion 104 shown includes a mounting bracket 106, which is integrally formed with the fixed portion 104 and includes at least one aperture 107 for each receiving fasteners 44 for attaching the fixed portion 104 to the side 24 of the container 12. The mounting bracket 106 is generally rectangular in shape, for example. The fasteners 44 are bolts and/or screws. Each offset hinge 102 also includes at least one shaft bearing or bushing 108 for rotatably receiving the shaft 20 to allow rotation of the shaft 20 with respect to the fixed portion 104.

The offset hinges 102 are evenly positioned, as desired by the customer, along the shaft 20 without interfering with the axle connectors 96, the support anchor members 98, corner braces 97 or container bracing as shown in FIG. 8. The offset hinges 102 can be fixed anywhere along the shaft 20, independent of the plurality of sleeve-type shaft connections 94.

The support anchor member 98 and offset hinge 102 in combination with the shaft 20 centerline provide 270° of rotation from open, wherein the cover is flush to the container side to minimize obstruction during loading of the container, as shown in FIG. 17, to close without exceeding the three inch legal maximum allowed beyond the side of the container 12. The configuration also minimizes the height above the container 12, thereby increasing maximum height of the container for highway travel.

Referring now to FIGS. 3-5, the moving means 19 includes the shaft 20 and an actuator 21. In one embodiment illustrated in FIG. 18, the actuator 21 includes a hydraulic cylinder 54, a housing 55, and translation means 56 for translating linear movement of the hydraulic cylinder 54 into rotary movement of the shaft 20. The housing unit 55 is designed to provide a mounting structure for mounting the actuator 21 to the container 12 without additional components. The hydraulic cylinder 54 is a reversible cylinder, which includes a piston 62 attached to a rod 64. The cylinder 54 includes a first port 66 and a second port 68. The rod 64 is attachable at a first rod end 70 to a chain 72 at a first chain end 74. A chain connector 76 attaches the first rod end 70 to the first chain end 74.

The chain 72 operably engages a first sprocket 78 proximate to the first chain end 74. The first sprocket 78 is attached to the shaft 20 and is positioned coaxially to an axis of the rotation 80 of the shaft 20. Preferably, the first sprocket 78 is connected to a flange 82 (shown in FIG. 6) associated with the shaft 20. The chain 72 then extends from the first sprocket 78 to operably engage a second sprocket 84. The chain 72 is connected at a second chain end 86 to a second rod end 88. The second chain end 86 is shown attached to the second rod end 88 using another connector 76.

The chain connectors 76 are rotatably fixed and axially moveable so that the position of the rod end 70 can be changed with respect to the first sprocket 78, thereby modifying the end point of the piston stroke for the open and closed position of the shaft 20. The modification of the end point of the piston stroke provides for easier mounting of the actuator 21 to the trailer by eliminating an exact angular position of the shaft 20 during assembly.

In operation, fluid enters the cylinder 54 through the first port 66 thereby exerting a force on the piston 62 causing the rod 64 and the chain end 74 to move linearly in a direction away from the first sprocket 78. In turn, the chain 72 operably engages the first sprocket 78 and causes the first sprocket 78 and the attached shaft 20 to rotatably move in a closed direction 90, thereby causing the supports 18 and the cover 16 to move in the closed direction 90 as shown in FIGS. 4 and 5.

Alternately, the fluid enters the cylinder through the second port 68 causing the piston 62 and the rod 64 to move in a direction towards the first sprocket 78 and thus causing chain end 74 to move in a direction toward the first sprocket. The chain 72 operably engages the first sprocket 78 and thus causes the first sprocket 78 to rotatably move the shaft 20 in an opened direction 92, thereby causing the supports 18 and the cover 16 to move in the opened direction 92 as shown in FIGS. 3 and 4. One stroke of the piston rod 64 corresponds to 270° of rotational movement of the shaft 20 in either the open or the closed position.

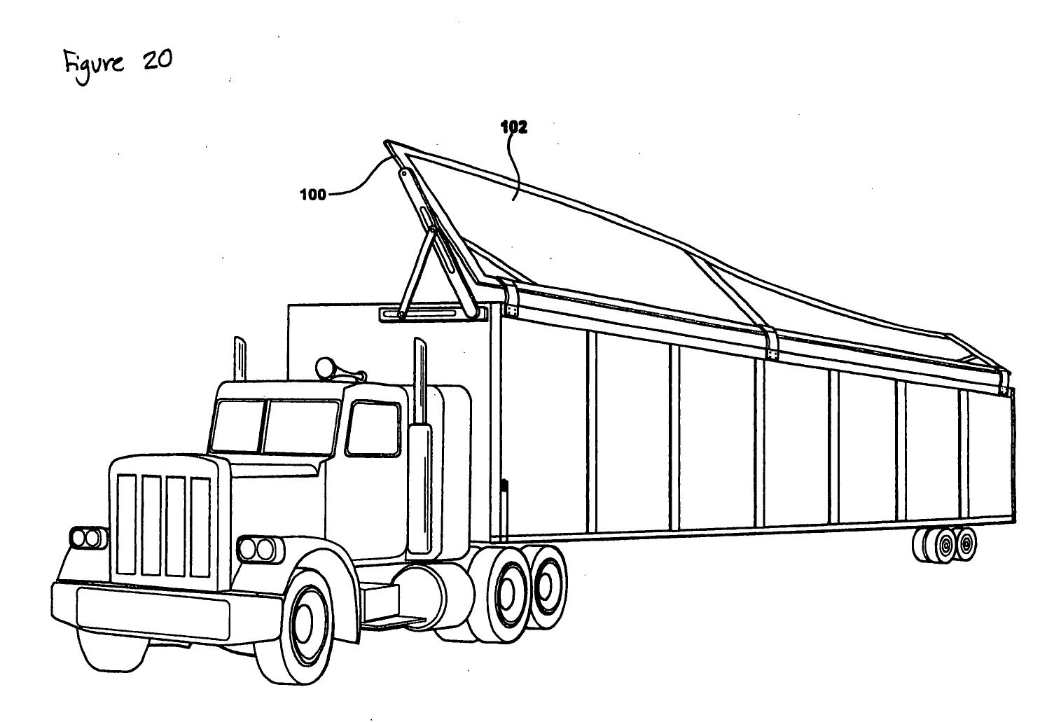

In an alternative embodiment illustrated in FIG. 19, the actuator 21, which is significantly lighter in weight, includes a first and second hydraulic cylinder 122, 124, each having a piston 125, 127 attached to a rod 126, 128 respectively. Each cylinder 122, 124 also include a first port 130, 134 and a second port 132, 136, respectively. The first port 130 of the first hydraulic cylinder 122 and the first port 134 of the second hydraulic cylinder 124 are connected to a fluid supply of the power source, not shown. The second port 132 of the first hydraulic cylinder 122 and the second port 136 of the second hydraulic cylinder 124 are also interconnected by a jump hose, not shown, through which the oil or other fluid flows freely to and from the first and second hydraulic cylinders 122, 124 depending on the position of the piston rods 126, 128 in the cylinders 122, 124.

The rod 126 of the first hydraulic cylinder 122 is attachable at a first rod end 138 to a chain 142 at a first chain end 144. The chain 142 operably engages a sprocket 148 proximate to the first chain end 144. The sprocket 148 is attached to the shaft 20 and is positioned coaxially to an axis of the rotation 80 of the shaft 20. The chain 142 is connected at a second chain end 146 to the rod 128 of the second hydraulic cylinder 124 at a first rod end 140.

Protruding from the second ends 150, 152, of the cylinders 122, 124, respectively, are threaded rods 154, 156 each having an adjusting nut 158 on the end. The nuts 158 are rotated on the threaded rods 154, 156 to provide angular adjustment of an actuator shaft, not shown. After the actuator 21 is assembled to the container, the hydraulic cylinders 122, 124 can be axially adjusted using the nuts 158 on the threaded rods 154, 156 to change the angular position of the shaft 20 by modifying the end of the piston stroke of the two piston rods 126, 128 so that the 270° angular motion will be achieved by the shaft 20. This eliminates the need to position the actuator 21 and shaft 20 at an exact angle when assembling the components to the container 12.

In operation, oil or other fluid enters cylinder 124 through the port 134 from the fluid supply of the power source and exits cylinder 122 through port 130 to the fluid supply of the power source. Simultaneously, fluid enters cylinder 122 through port 132 from cylinder 124 through port 136. A force is exerted on the piston 125, causing the rod 126 and chain 142 to move linearly in a direction toward the sprocket 148. Simultaneously, as the fluid exits cylinder 124 the piston 127, rod 128 and chain 142 move linearly in a direction away from the sprocket 148. As the chain end 144 moves linearly toward the sprocket 148 and chain end 146 moves away from the sprocket 148, the chain 142 operably engages the sprocket 148 and causes the sprocket 148 and the attached shaft 20 to rotatably move in an open direction 92, thereby causing the supports 18 and the cover 16 to move in the open direction 92. One total stroke of the piston rod 126 converts to 270° of rotational movement of the shaft 20 to the open position as shown in FIGS. 3 and 4.

Alternately, the fluid enters cylinder 122 through the port 130 from the fluid supply of the power source and exits cylinder 124 through port 134 to the fluid supply of the power source. Simultaneously, fluid enters cylinder 124 through port 136 from cylinder 122 through port 132. A force is exerted on the piston 127, causing the rod 128 and chain 142 to move linearly in a direction toward the sprocket 148. As the fluid exits cylinder 122 through the second port 134, the piston rod 126 and accordingly, the chain 142 to move linearly in a direction away from the sprocket 148. As the chain end 144 moves linearly away from the sprocket 148 and chain end 146 moves linearly toward the sprocket 148, the chain 142 operably engages the sprocket 148 and causes the sprocket 148 to rotatably move the shaft 20 in a closed direction 90, thereby causing the supports 18 and the cover 16 to move in the closed direction 90. One total stroke of the piston rod 128 converts to 270° of rotational movement of the shaft 20 to the closed position as shown in FIGS. 4 and 5.

The components of the system, as described in the embodiments above, are bolted onto the container during assembly. The system does not require that the components be permanently welded onto the container, allowing damaged components to be replaced more easily.

The rotational stiffness of the actuated shaft system provides improved hold-down of the cover during transit, increases resistance to deflection by the wind during opening and closing of the cover. In addition, when the cover is moved over the center during opening and closing operation, the cover is not subjected to a torsional lag that often produces an unsafe slamming of the cover and reduces the life of the cover, and thereby minimizes the load applied to the actuator.

In addition to the deflection and stress on the cover assembly that can result in reduced longevity in the above-described prior covering systems, it has been observed that the lead support 100 according to FIG. 20 is the drive member to the system. In the situation where the drive member is inoperable, the entire system is inoperable. The invention as described herein eliminates this dependency on the operation of the lead support for operability of the entire system by driving the shaft system directly.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An apparatus for opening and closing a cover of a container, mounted on a truck, the apparatus comprising:
a plurality of supports attachable to the cover;
means for moving each of the supports between an opened position and a closed position;
means for attaching an end of each support to the moving means; and
means for pivotally attaching the moving means to the container.

2. The apparatus of claim 1, wherein the attaching means further comprises a plurality support members, the plurality of support members fixedly coupled to the moving means.

3. The apparatus of claim 2, wherein each of the plurality of support members further comprises a connector attachable an end of the respective support.

4. The apparatus of claim 1, wherein the pivotally attaching means further comprises:
a fixed portion attachable to the container; and
a receiving portion for rotatably receiving the moving means.

5. The apparatus of claim 4, wherein the fixed portion further comprises at least one aperture for receiving means for attaching the fixed portion to the container.

6. The apparatus of claim 5, wherein the attaching means further comprises at least one fastener.

7. The apparatus of claim 4, wherein the receiving portion further comprises at least one bushing for rotatably receiving the moving means.

8. The apparatus of claim 1, wherein the moving means further comprises:
a shaft coupled to each support and pivotally mounted parallel to and above a top edge of the container; and
an actuator for providing rotary motion to the shaft such that the shaft rotates about an axis of the shaft.

9. The apparatus of claim 8 wherein the axis of the shaft is inboard of the side of the container, the cover supports each having an axis perpendicular to and offset below the axis of the shaft.

10. The apparatus of claim 8, wherein the shaft has a tubular shape when viewed in a cross-section perpendicular to a longitudinal axis of the shaft.

11. The apparatus of claim 8, wherein the shaft further comprises:
a plurality of shaft lengths; and
means for connecting the plurality of shaft lengths end to end.

12. The apparatus of claim 11, wherein the connecting means further comprises at least one sleeve connector.

13. The apparatus of claim 12, wherein the attaching means further comprises at least one support member having a connector for attaching an end of the respective support to the shaft, the at least one support member being interposed between shaft length ends in at least one sleeve connector.

14. The apparatus of claim 8, wherein the actuator further comprises:
a first and second hydraulic cylinder for providing linear motion; and
means for translating linear motion of the first and second hydraulic cylinders into rotary movement of the shaft about the axis of the shaft.

15. The apparatus of claim 14, wherein the translation means further comprises:
a first rod attachable to a first end of the first hydraulic cylinder;
a second rod attachable to a first end of the second hydraulic cylinder;
a chain attachable at a first chain end to a first end of the first rod and at a second chain end to a first end of the second rod; and
a sprocket operably engaged with the chain where the sprocket is attachable to the shaft.

16. The apparatus of claim 15, wherein the first and second rods, the chain, and the sprocket are positioned co-planar with respect to each other.

17. The apparatus of claim 15, wherein a second end of the first and second hydraulic cylinders further comprises a threaded rod, each threaded rod having a nut attached for angular adjustment of an actuator shaft.

18. An apparatus for opening and closing a cover for an open top container associated with a truck or truck trailer, the cover having a plurality of supports to support a covering material, the apparatus comprising:
a rotatable shaft having an axis positioned inboard of a side of the container, the shaft connectible to an end of each of the cover supports and configured to provide a torsion force to each of the cover supports to move the cover between an opened position and a closed position, the cover supports each having a axis offset below the shaft axis;
a plurality of support members pivotably attaching respective ones of the cover supports to the shaft, the support members fixedly coupled to the shaft;
a plurality of hinges rotatably receiving and pivotally mounting the shaft proximate to and parallel to a side of the container, the plurality of hinges attachable to the side of the container; and
an actuator for rotatably moving the shaft about the axis of the shaft.

19. The apparatus of claim 18, wherein the actuator further comprises:
first and second hydraulic cylinders for providing linear motion; and
means for translating linear motion of the first and second hydraulic cylinders into rotary movement of the shaft about the axis of the shaft.

20. The apparatus of claim 19, wherein the translation means further comprises:
a first rod attachable to a first end of the first hydraulic cylinder;
a second rod attachable to a first end of the second hydraulic cylinder;
a chain attachable at a first chain end to the first rod and at a second chain end to the second rod;
a second end of the first and second hydraulic cylinders having a threaded rod, each threaded rod having a nut attached for angular adjustment of an actuator shaft; and
a sprocket operably engaged with the chain and attachable to the shaft.
